(19) United States
(12) Patent Application Publication
(10) Pub. No.: US 2013/0103444 A1
(43) Pub. Date: Apr. 25, 2013

(54) GROUP SCHEDULING AND ASSIGNMENT OF RESOURCES

(71) Applicants: Sulabh Agarwal, Madison, WI (US); Sean Bernard Bina, Fitchburg, WI (US); Philip Joshua Lindemann, Madison, WI (US)

(72) Inventors: Sulabh Agarwal, Madison, WI (US); Sean Bernard Bina, Fitchburg, WI (US); Philip Joshua Lindemann, Madison, WI (US)

(73) Assignee: Epic Systems Corporation

(21) Appl. No.: 13/278,485

(22) Filed: Oct. 21, 2011

(51) Int. Cl. G06Q 10/06

(52) U.S. Cl. 705/7.14; 705/7.19

(57) ABSTRACT

A system, computer-readable medium, and method for scheduling use of a resource based on a resource type and of assigning the resource to an appointment are provided. A resource type definition defining first characteristics of a resource type is received. An appointment type definition defining third characteristics of an appointment type is received. Appointment parameters associated with an appointment to schedule are received. The appointment parameters include the appointment type and the resource type to be used in conducting the appointment. The appointment is scheduled for a date and a time window using a number of resources of the resource type available on the date and during the time window and information associated with previously scheduled appointments. After scheduling the appointment, a resource of the resource type is assigned to the scheduled appointment.

### BACKGROUND

According to usual procedures, appointments are scheduled by office personnel in response to a contact from a patient wanting to schedule an appointment. Various computerized scheduling systems have been developed, which facilitate matching patients to available appointment times. Medical facilities further schedule cases for surgical procedures though generally using a different scheduling tool due to the different scheduling rules applied in scheduling appointments in contrast to surgical procedures. However, some medical personnel may be needed to support both appointments and surgical procedures. For example, an anesthesiologist may be needed to support an examination of a patient as well as a surgical procedure during the same day. Because the tools used to schedule these dual task resources are not typically integrated, the scheduling of these types of personnel is inefficient and error prone.

In some cases, the specific medical personnel assigned to perform a task may not be known when the task is scheduled. For example, a surgery may be scheduled a few weeks into the future when it is not known exactly which anesthesiologist will be on duty to administer anesthesia during the surgery. As a result, a scheduling tool is needed to evaluate a pool of resources to determine if a task can be scheduled and to later in time assign a specific resource to the task in an efficient manner.

In a health care setting, it is further necessary to effectively and comprehensively manage the progress of tasks, such as a surgery or clinic appointment, from beginning to end. Tasks are usually scheduled, but cannot be managed based on the schedule alone because the tasks rarely proceed according to the schedule due to the many variables involved. For example, a surgical procedure in an operating room may exceed its scheduled time because one of the surgical procedures was more complicated than expected. Conversely, a surgical procedure could be completed earlier than its scheduled time because a scheduled surgical procedure could not be performed or was deemed unnecessary or unadvisable at some point during the surgical procedure. Thus, a flexible scheduling tool to allow the efficient movement of resources between tasks is needed.

### SUMMARY

In an example embodiment, a method for scheduling use of a resource based on a resource type and of assigning the resource to an appointment is provided. A resource type definition defining first characteristics of a resource type is received. An appointment type definition defining third characteristics of an appointment type is received. Appointment parameters associated with an appointment to schedule are received. The appointment parameters include the appointment type and the resource type to be used in conducting the appointment. The appointment is scheduled for a date and a time window using a number of resources of the resource type available on the date and during the time window and information associated with previously scheduled appointments. After scheduling the appointment, a resource of the resource type is assigned to the scheduled appointment.

In another example embodiment, a computer-readable medium is provided having stored thereon computer-readable instructions that when executed by a computing device, cause the computing device to perform the method of scheduling use of a resource based on a resource type and of assigning the resource to an appointment.

In yet another example embodiment, a system is provided. The system includes, but is not limited to, a processor and the computer-readable medium operably coupled to the processor. The computer-readable medium has instructions stored thereon that when executed by the processor, cause the system to perform the method of scheduling use of a resource based on a resource type and of assigning the resource to an appointment.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a block diagram of a scheduling system in accordance with an illustrative embodiment.

FIG. 2 depicts a block diagram of a user computing device of the illustrative system of FIG. 1 in accordance with an illustrative embodiment.

FIG. 3 depicts a block diagram of a server computing device of the illustrative system of FIG. 1 in accordance with an illustrative embodiment.

FIG. 4 depicts a flow diagram illustrating example operations performed through use of a scheduling application of the user computing device of FIG. 2 in accordance with an illustrative embodiment.

FIGS. 5-19 depict user interface windows of the scheduling application of FIG. 4 in accordance with an illustrative embodiment.

### DETAILED DESCRIPTION

Hereinafter, the embodiments are described in relation to a medical facility medical data, and medical resources. Nevertheless, it should be appreciated that the described embodiments can be applied in non-medical industries. For example, any application in which shared resources may be scheduled to support multiple, different types of tasks may utilize the described embodiments.

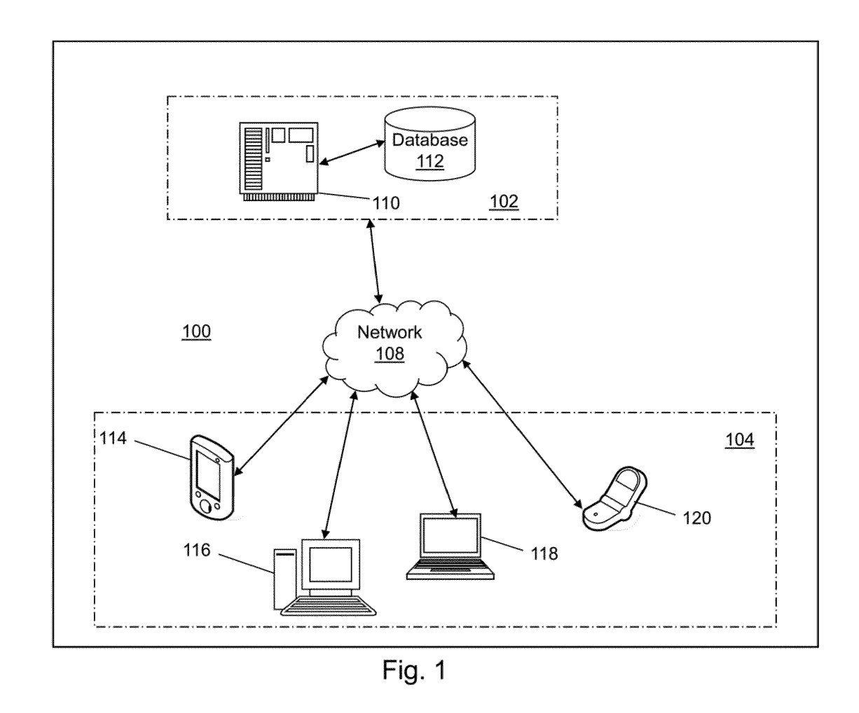

With reference to FIG. 1, a block diagram of a scheduling system 100 is shown in accordance with an illustrative embodiment. In an illustrative embodiment, scheduling system 100 may include a data processing system 102, a plurality of user systems 104, and a network 108. Network 108 may include one or more networks of the same or different types. Network 108 can be any type of wired and/or wireless public or private network including a cellular network, a local area network, a wide area network such as the Internet, etc. Network 108 further may be comprised of sub-networks and consist of any number of devices.

Data processing system 102 may include a server computing device 110 and a database 112. Server computing device 110 may be a computer of any form factor. Data processing system 102 further may include a plurality of server computing devices that may be connected directly or through network 108. Server computing device 110 includes or can access database 112 either through a direct connection or through network 108.

Database 112 is a data repository for scheduling system 100. Database 112 may include a plurality of databases that may be organized into multiple database tiers to improve data management and access. Database 112 may utilize various database technologies and a variety of different formats as known to those skilled in the art including a file system, a relational database, a system of tables, a structured query language database, etc. Database 112 may be implemented as a single database or as multiple databases stored in different storage locations distributed over the Internet or other heterogeneous storage infrastructures.

The plurality of user systems 104 may include one or more computing devices. The one or more computing devices send and receive signals through network 108 to/from another of the one or more computing devices and/or to/from data processing system 102. The plurality of user systems 104 can include any number and type of computing devices that may be organized into subnets. The one or more computing devices may include computers of any form factor such as a personal digital assistant 114, a desktop 116, a laptop 118, an integrated messaging device, a cellular telephone 120, a smart phone, a pager, a tablet computer, etc. The plurality of user systems 104 may include additional types of devices.

The one or more computing devices communicate using various transmission media that may be wired or wireless as known to those skilled in the art. The one or more computing devices may communicate information as peers in a peer-to-peer network using network 108. Users may use a computing device of the one or more computing devices to receive information related to patients, to check a status of a patient, to update a status of the patient, to review test results from a data generation system, to schedule a patient for a procedure or appointment, to assign a resource to the procedure/appointment, etc.

The components of scheduling system 100 may be positioned in a single location, a single facility, and/or may be remote from one another. Scheduling system 100 may be integrated in one or more computing devices. For example, the components of scheduling system 100 may be integrated into a single computing device. One or more of the components of scheduling system 100 may be connected directly, for example, using a cable for transmitting information between systems. One or more of the components of scheduling system 100 may be connected using network 108 without limitation.

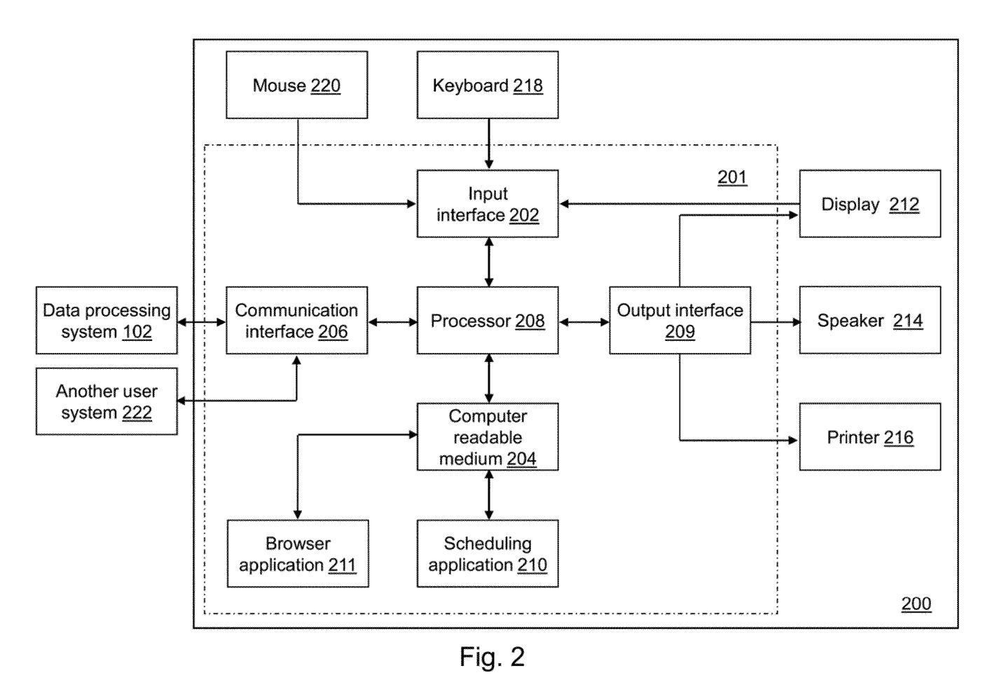

With reference to FIG. 2, a block diagram of a user device 201 of a user system 200 is shown in accordance with an example embodiment. User system 200 is an example computing system of the plurality of user systems 104. User system 200 may include user device 201, a display 212, a speaker 214, a printer 216, a keyboard 218, and a mouse 220. User device 201 may include an input interface 202, a computer-readable medium 204, a communication interface 206, a processor 208, an output interface 209, a scheduling application 210, and a browser application 211. Different and additional components may be incorporated into user system 200 and/or user device 201.

Input interface 202 provides an interface for receiving information from the user for entry into user device 201 as known to those skilled in the art. Input interface 202 may use various input technologies including, but not limited to, a keyboard 218, a pen and touch screen, a mouse 220, a track ball, a touch screen, a keypad, one or more buttons, etc. to allow the user to enter information into user device 201 or to make selections presented in a user interface displayed on display 212. The same interface may support both input interface 202 and output interface 209. For example, a touch screen both allows user input and presents output to the user. User device 201 may have one or more input interfaces that use the same or a different input interface technology. Keyboard 218, the pen and touch screen, mouse 220, the track ball, the touch screen, the keypad, the one or more buttons, further may be accessible by user device 201 through communication interface 206.

Computer-readable medium 204 is an electronic holding place or storage for information so that the information can be accessed by processor 208 as known to those skilled in the art. Computer-readable medium 204 can include, but is not limited to, any type of random access memory (RAM), any type of read only memory (ROM), any type of flash memory, etc. such as magnetic storage devices (e.g., hard disk, floppy disk, magnetic strips, . . . ), optical discs (e.g., CD, DVD, . . . ), smart cards, flash memory devices, etc. User device 201 may have one or more computer-readable media that use the same or a different memory media technology. User device 201 also may have one or more drives that support the loading of a memory media such as a CD or DVD. Computer-readable medium 204 may provide the electronic storage medium for database 112 that may optionally be stored on user device 201.

Communication interface 206 provides an interface for receiving and transmitting data between devices using various protocols, transmission technologies, and media as known to those skilled in the art. Communication interface 206 may support communication using various transmission media that may be wired or wireless. User device 201 may have one or more communication interfaces that use the same or a different communication interface technology. Data and messages may be transferred between user system 200 and data processing system 102 and/or between another user system 222 of the plurality of user systems 104 using communication interface 206.

Processor 208 executes instructions as known to those skilled in the art. The instructions may be carried out by a special purpose computer, logic circuits, or hardware circuits. Thus, processor 208 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 208 executes an instruction, meaning that it performs/controls the operations called for by that instruction. Processor 208 operably couples with output interface 209, with input interface 202, with computer-readable medium 204, and with communication interface 206 to receive, to send, and to process information. Processor 208 may retrieve a set of instructions from a permanent memory device and copy the instructions in an executable form to a temporary memory device that is generally some form of RAM. User device 201 may include a plurality of processors that use the same or a different processing technology.

Output interface 209 provides an interface for outputting information for review by a user of user device 201. For example, output interface 209 may include an interface to display 212, speaker 214, printer 216, etc. Display 212 may be a thin film transistor display, a light emitting diode display, a liquid crystal display, or any of a variety of different displays known to those skilled in the art. Speaker 214 may be any of a variety of speakers as known to those skilled in the art. Printer 216 may be any of a variety of printers as known to those skilled in the art. User device 201 may have one or more output interfaces that use the same or a different interface technology. Display 212, speaker 214, and/or printer 216 further may be accessible by user device 201 through communication interface 206.

Scheduling application 210 performs operations associated with scheduling appointments and assigning resources to the scheduled appointments. As used herein, appointments include physician appointments, radiology appointments, therapist appointments, as well as appointments for procedures such as surgeries and emergency procedures though this is not intended to be limiting. Some or all of the operations described herein may be embodied in scheduling application 210. The operations may be implemented using hardware, firmware, software, or any combination of these methods. With reference to the example embodiment of FIG. 2, scheduling application 210 is implemented in software (comprised of computer-readable and/or computer-executable instructions) stored in computer-readable medium 204 and accessible by processor 208 for execution of the instructions that embody the operations of scheduling application 210. Scheduling application 210 may be written using one or more programming languages, assembly languages, scripting languages, etc. Scheduling application 210 may be implemented as a plug-in or be otherwise integrated with browser application 211.

Scheduling application 210 may be implemented as a Web application executing, for example, at user device 201 and/or server computing device 110 that supports any type of communication protocol. For example, scheduling application 210 may be configured to receive and to send hypertext transport protocol (HTTP) messages along with optional additional data content which may include web pages such as hypertext markup language (HTML) documents and linked objects from/to server computing device 110 and/or database 112.

Scheduling application 210 further may provide information or data organized in the form of a website accessible over network 108. A website may comprise multiple web pages that display a specific set of information and may contain hyperlinks to other web pages with related or additional information. Each web page is identified by a uniform resource locator (URL) that includes the location or address of the computing device that contains the resource to be accessed in addition to the location of the resource on that computing device. The type of file or resource depends on the Internet application protocol. For example, HTTP and HTTP secure (HTTPS) describe a web page to be accessed with a browser application. The file accessed may be a simple text file, an image file, an audio file, a video file, an executable, a common gateway interface application, a Java applet, or any other type of file supported by HTTP.

Browser application 211 performs operations associated with retrieving, presenting, and traversing information resources provided by a web application and/or web server as known to those skilled in the art. An information resource is identified by a uniform resource identifier (URI) and may be a web page, image, video, or other piece of content. Hyperlinks in resources enable users to navigate to related resources. Example browser applications 211 include Navigator by Netscape Communications Corporation, Firefox® by Mozilla Corporation, Opera by Opera Software Corporation, Internet Explorer® by Microsoft Corporation, Safari by Apple Inc., Chrome by Google Inc., etc. as known to those skilled in the art.

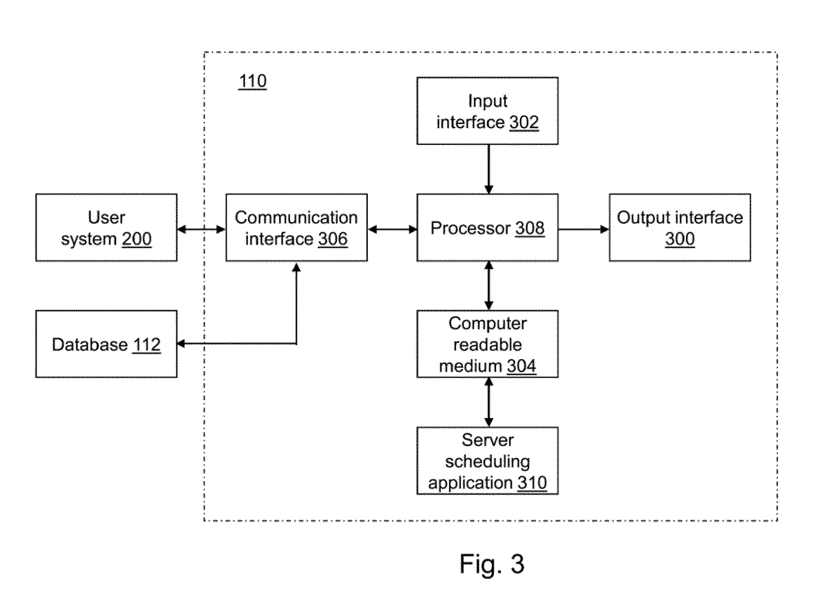

With reference to FIG. 3, a block diagram of server computing device 110 of scheduling system 100 is shown in accordance with an example embodiment. Server computing device 110 may include a second output interface 300, a second input interface 302, a second computer-readable medium 304, a second communication interface 306, a second processor 308, and a server scheduling application 310. Different and additional components may be incorporated into server computing device 110.

Second output interface 300 provides the same or similar functionality as that described with reference to output interface 209 of user device 201. Second input interface 302 provides the same or similar functionality as that described with reference to input interface 202 of user device 201. Second computer-readable medium 304 provides the same or similar functionality as that described with reference to computer-readable medium 204 of user device 201. Second communication interface 306 provides the same or similar functionality as that described with reference to communication interface 206 of user device 201. Second processor 308 provides the same or similar functionality as that described with reference to processor 208 of user device 201. Server scheduling application 310 and scheduling application 210 may be the same or different applications or part of an integrated, distributed application supporting some or all of the same types of functionality as described herein. As an example, scheduling application 210 in combination with server scheduling application 310 may reference functionality provided as part of an integrated health care management software application such as those offered by Epic Systems Corporation and/or other software vendors.

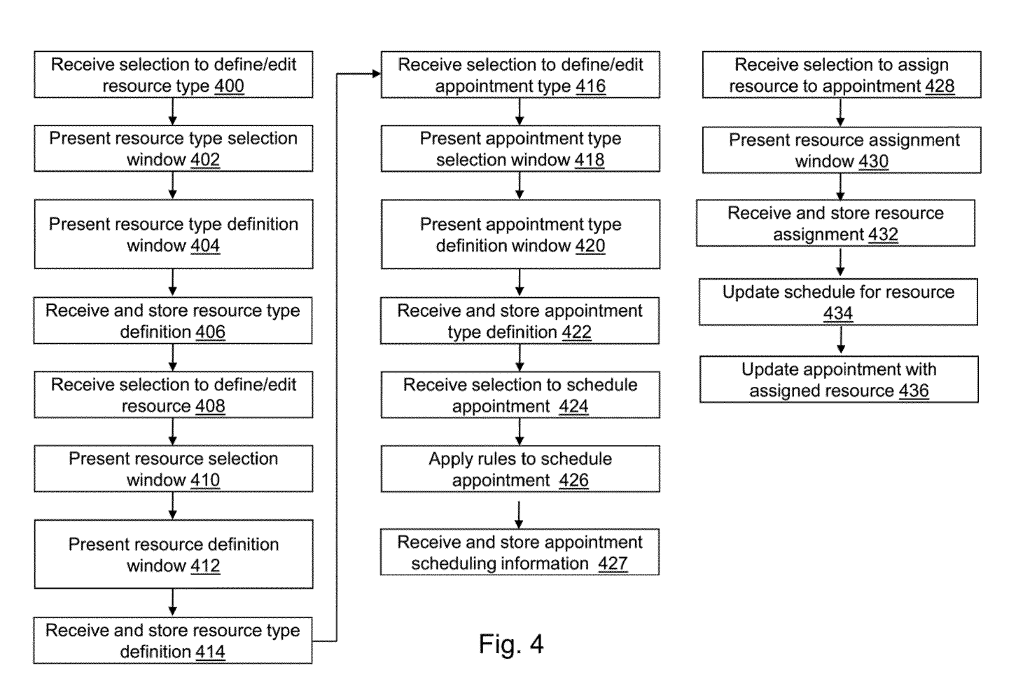

With reference to FIG. 4, example operations performed by scheduling application 210 and/or server scheduling application 310, alone or in combination, are described. Thus, the functionality described may be performed by scheduling application 210 alone, by server scheduling application 310 alone, or through any integration of functionality desired between scheduling application 210 and server scheduling application 310. Additional, fewer, or different operations may be performed depending on the embodiment. The order of presentation of the operations of FIG. 4 is not intended to be limiting. A user can interact with one or more user interface windows presented to the user in display 212 under control of scheduling application 210 and/or server scheduling application 310 independently or through use of browser application 211 in an order selectable by the user. Thus, although some of the operational flows are presented in sequence, the various operations may be performed in various repetitions, concurrently, and/or in other orders than those that are illustrated.

A user may execute scheduling application 210 and/or server scheduling application 310. For example, the user may “login” to use scheduling application 210 as known to a person of skill in the art. Execution of scheduling application 210 may cause presentation of a user interface window, which may include a plurality of menus and selectors such as drop down menus, buttons, text boxes, hyperlinks, additional windows, etc. associated with scheduling application 210. As understood by a person of skill in the art, the user interface window is presented under control of user device 201 on display 212 executing an application such as scheduling application 210 and/or server scheduling application 310. As the user interacts with scheduling application 210, different user interface windows are presented to provide the user with more or less detailed information related to aspects of the patient's medical history, allocation of resources, scheduling a resource, etc. Thus, as known to a person of skill in the art, scheduling application 210 receives an indicator associated with an interaction by the user with a user interface window presented under control of scheduling application 210. Based on the received indicator, scheduling application 210 performs one or more operations that may involve messaging between user device 201, server computing device 110, and/or another user system 222.

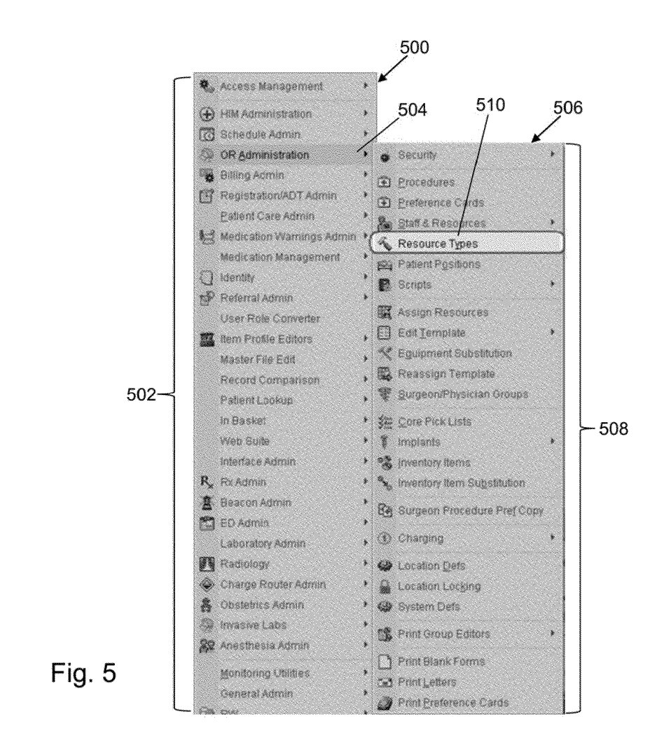

In an operation 400, an indicator is received indicating that the user has selected a first selector to define and/or edit a resource type. As a first example, with reference to FIG. 5, a portion of a first user interface window 500 is shown in accordance with an illustrative embodiment. First user interface window 500 may include a plurality of selectors 502. A selector of the plurality of selectors may be associated with an application that performs an administration and/or management task associated with the integrated health care management software application. For example, the plurality of selectors 502 may include an operating room administration selector 504. Through input interface 202, operating room administration selector 504 is selected. For example, the user may use mouse 220 to scroll to operating room administration selector 504. Scrolling to operating room administration selector 504 may cause presentation of a second user interface window 506 that may include a second plurality of selectors 508. The second plurality of selectors 508 may include a resource type selector 510 that is selected by the user. In response, as understood by a person of skill in the art, scheduling application 210 and/or server scheduling application 310 receives an indicator indicating the selection.

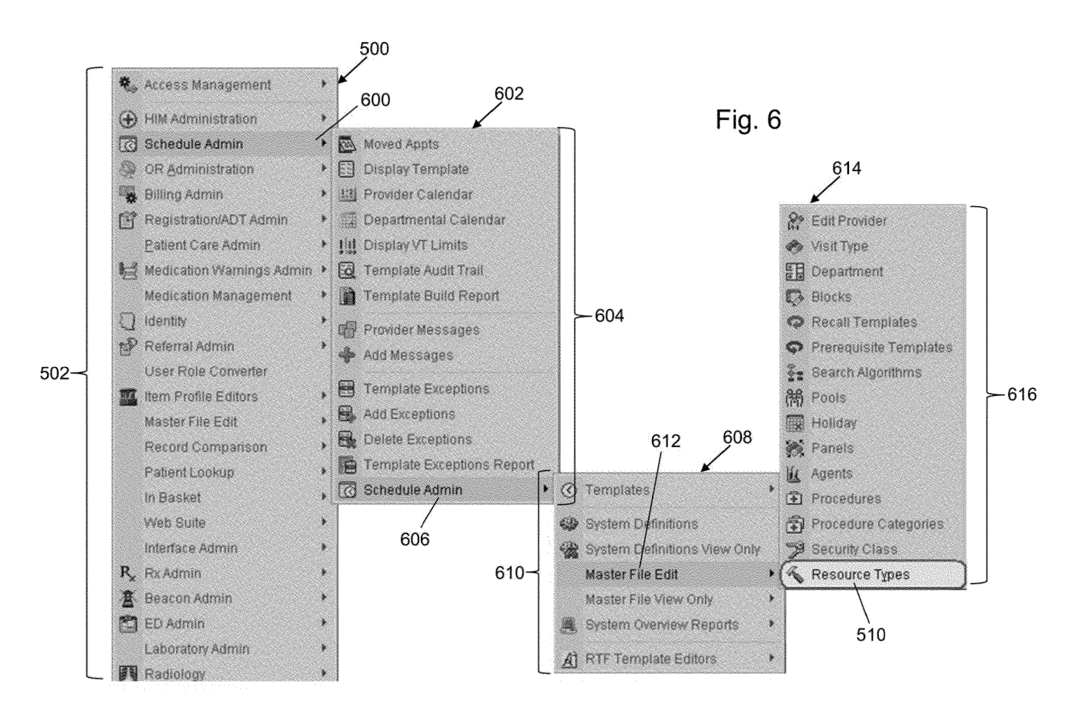

As shown with reference to FIG. 6, the plurality of selectors 502 may further include a schedule administration selector 600. Scrolling to schedule administration selector 600 may cause presentation of a third user interface window 602 that may include a third plurality of selectors 604. The third plurality of selectors 604 may include a second schedule administration selector 606 that is selected by the user by scrolling to second schedule administration selector 606, which causes presentation of a fourth user interface window 608 that may include a fourth plurality of selectors 610. The fourth plurality of selectors 610 may include a master file edit selector 612. Scrolling to master file edit selector 612 may cause presentation of a fifth user interface window 614 that may include a fifth plurality of selectors 616. The fifth plurality of selectors 616 may include resource type selector 510 from which the user may trigger opening of a new user interface window.

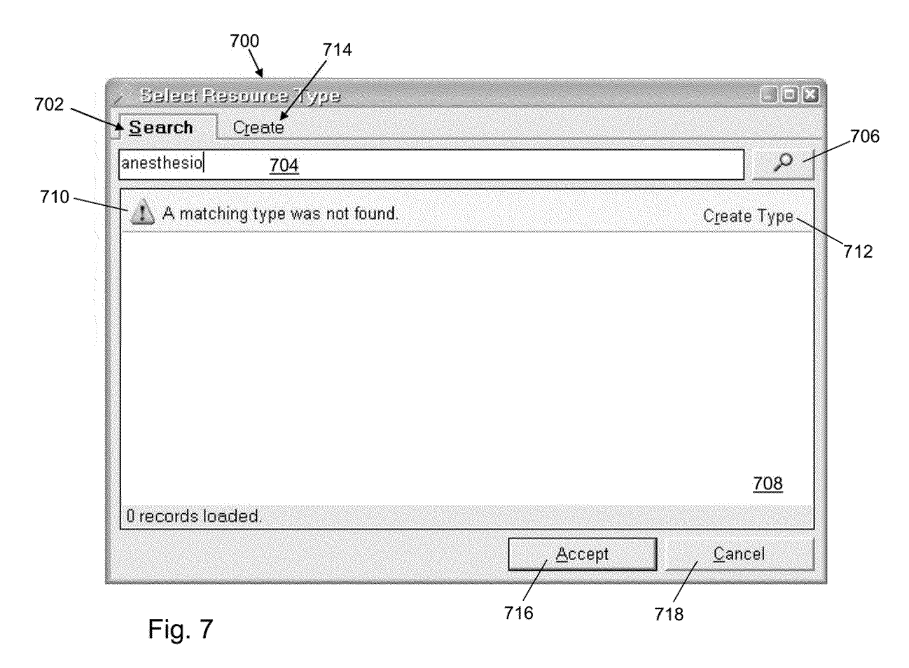

For example, in an operation 402 and with reference to FIG. 7, a resource type selection window 700 may be presented in display 212 after selection of resource type selector 510 by the user. Resource type selection window 700 may include a search tab 702, a create tab 714, an accept button 716, and a cancel button 718. Search tab 702 may include a search box 704, a search execute button 706, and a search results window 708. After user entry of one or more alphanumeric characters into search box 704, the user selects search execute button 706. After receipt of a search execute indicator based on user selection of search execute button 706, a query of database 112 may be performed for resource types including the one or more alphanumeric characters. Any matching resource types are indicated in search results window 708. As understood by a person of skill in the art, a listed resource type may be selected by the user from any resource types listed in search results window 708. Upon receipt of an indication of a user selection of accept button 716, resource type selection window 700 is closed, and a window associated with the selected resource type(s) is presented to the user. Upon receipt of an indication of a user selection of cancel button 718, resource type selection window 700 is closed.

As used herein, the term “resource type” includes a type of person who may have specific qualifications to perform a task, a type of equipment used to perform the task, a type of area in which to perform the task, etc. though this is not intended to be limiting, but merely to provide an illustrative field of use. For example, when applied to the medical field, the type of person may include a medical field worker such as a physician, a physician's assistant, a surgeon, a nurse, a nurse practitioner, a radiologist, an anesthesiologist, a physical therapist, an occupational therapist, a speech therapist, a respiratory therapist, etc. When applied to the medical field, the type of equipment may include a mammography machine, an x-ray machine, a computed tomography machine, an ultrasound machine, a magnetic resonance imaging machine, a c-arm, an instrument tray, etc. When applied to the medical field, the type of area may include an operating room, a room housing a piece of equipment, a laboratory, a room for seeing patients, a room for treating patients, etc.

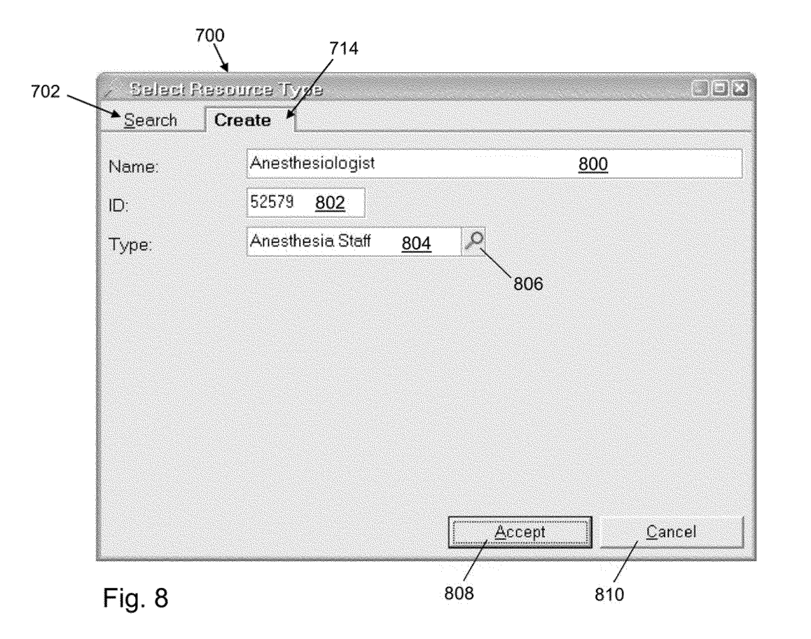

In the illustrative embodiment of FIG. 7, no match to the alphanumeric characters “anesthesio” was found. As a result, a warning message 710 is presented in combination with a create type button 712 in search results window 708. Selection of create tab 714 or create type button 712 may cause presentation of resource type selection window 700 as shown with reference to FIG. 8. Create tab 714 may include a resource type name box 800, a resource identifier box 802, a type of resource selector 804, a second search execute button 806, a second accept button 808, and a second cancel button 810. The user may enter alphanumeric characters in resource type name box 800 to provide a name for the resource type to be created. The user may enter alphanumeric characters in resource identifier box 802 to provide an identifier for the resource type to be created. The identifier also may be predefined and/or may be used as a more compact representation for the resource type, for example, by using fewer bits of memory for storage of the identifier. For example, the identifier may be limited to a numeric value having a predefined number of digits.

Type of resource selector 804 may include a text entry window or a drop down list from which the user may select one or more types of resources. To facilitate selection of a type of resource, second search execute button 806 may be used to search for a type of resource including any alphanumeric characters entered in type of resource selector 804. Type of resource selector 804 may list types of personnel who have specific qualifications to perform a task, a type of equipment used to perform the task, a type of area in which the task is performed, etc. Characteristics of each type of resource listed in type of resource selector 804 may further be defined using another of the plurality of selectors 502. Upon receipt of an indication of a user selection of second cancel button 810, resource type selection window 700 is closed.

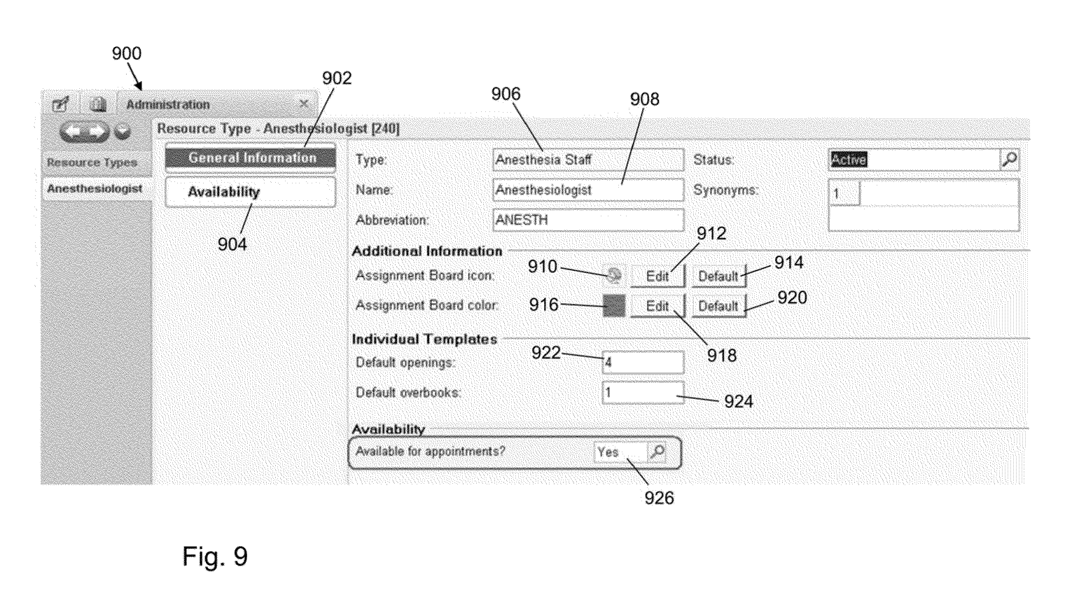

In an operation 404 and with reference to FIG. 9, a portion of a resource type definition window 900 is presented in display 212 after receipt of an indication of a user selection of second accept button 808. Resource type definition window 900 may include a general information tab 902 and an availability tab 904. General information tab 902 may include a type of resource indicator 906, a second resource type name box 908, an icon indicator 910, an icon indicator edit button 912, an icon indicator default button 914, a color indicator 916, a color indicator edit button 918, a color indicator default button 920, a default opening box 922, a default overbook box 924, and an availability selector 926. The data indicated in type of resource indicator 906 corresponds to that entered into or selected from type of resource selector 804. The alphanumeric data indicated in second resource type name box 908 corresponds to that entered into resource type name box 800.

Icon indicator 910 presents an example of an icon used in a presented schedule to indicate use of or a need for the resource type during an appointment. Selection of icon indicator edit button 912 allows the user to select a different icon to use in the presented schedule to indicate the resource type. Selection of icon indicator default button 914 sets icon indicator 910 to a default icon.

Color indicator 916 presents an example of a color used in the presented schedule to indicate use of or a need for the resource type during an appointment. Selection of indicator edit button 918 allows the user to select a different color to use in the presented schedule to indicate the resource type. Selection of indicator default button 920 sets color indicator 916 to a default color.

Default opening box 922 may include a numerical entry window or a drop down list from which the user may select or enter a number of scheduled tasks for which an individual resource of the resource type can be simultaneously assigned. Default overbook box 924 may include a numerical entry window or a drop down list from which the user may select or enter a number of scheduled tasks for which the individual resource of the resource type can be simultaneously assigned in excess of the value entered in default opening box 922.

Availability selector 926 may include a drop down selection list from which the user can select one or more tasks for which the resource type can be assigned. For example, the user may indicate that an anesthesiologist resource type can be assigned to operating room tasks as well as other appointment tasks such as a radiology appointment task. The one or more tasks, of course, depend on the type of application for which scheduling application 210 and/or server scheduling application 310 are specifically designed.

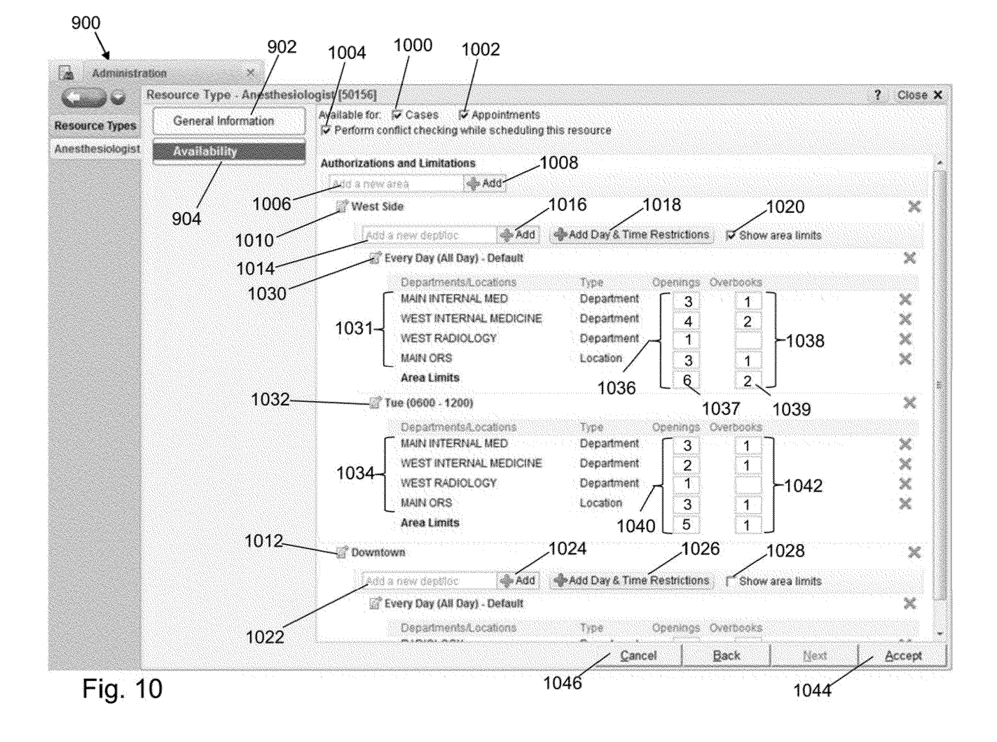

With reference to FIG. 10, a second portion of resource type definition window 900 is presented in display 212 after receipt of an indication of a user selection of availability tab 904. Availability tab 904 may include one or more selectors associated with the one or more tasks for which the resource type can be assigned. For example, the one or more selectors may include a first task selector 1000 associated with operating room tasks and a second task selector 1002 associated with appointment tasks.

Availability tab 904 further may include a conflict checking selector 1004 that may provide an indicator of whether or not conflict checking is performed when the resource type is scheduled. If conflict checking selector 1004 indicates that conflict checking is not performed when the resource type is scheduled, the remainder of availability tab 904 may be blank. For example, if conflict checking selector 1004 comprises a check box, no check in conflict checking selector 1004 may result in the remainder of availability tab 904 being blank.

If conflict checking selector 1004 indicates that conflict checking is performed when the resource type is scheduled, availability tab 904 further may include a location text box 1006 and a location add button 1008. Thus, conflict checking rules may be defined for the resource type based on the location of the workplace. For example, different allocation rules for an anesthesiologist may be defined based on the hospital or clinic. If no areas are added, the conflict checking for the resource type may be based on the values entered in default opening box 922 and default overbook box 924.

A user may enter a name for a location in location text box 1006 and then select location add button 1008 to add the location to the conflict rules. As a result, a first location indicator 1010 that includes the entered name may be created in availability tab 904. The user may create one or more locations. Thus, a user may name and add a second location, thereby creating a second location indicator 1012 that includes a second entered name that is created in availability tab 904. In an illustrative embodiment, the locations may be associated with facilities, such as a “West Side” facility and a “Downtown” facility.

The conflict checking rules may further be defined based on an area within a facility. For example, separate conflict rules may be defined for a department in a facility though the facility may be divided into other subdivisions or areas such as operating rooms, types of laboratories or laboratories as a group, imaging areas, etc. As a result, a first department text box 1014, a first department add button 1016, a first department add time/date restriction button 1018, and a first show area limit selector 1020 may be associated with first location indicator 1010. A second department text box 1022, a second department add button 1024, a second department add time/date restriction button 1026, and a second show area limit selector 1028 may be associated with second location indicator 1012. As an example, a user may enter a name for a department in first department text box 1014 and select first department add button 1016 to add the department to the conflict rules. The user may create one or more areas. As a result, a plurality of area indicators 1031 that include the entered names may be created in availability tab 904 in association with first location indicator 1010.

Associated with the plurality of area indicators 1031 may be opening boxes 1036 and overbook boxes 1038 such that each department has an associated opening box and an associated overbook box which the user may use to select or enter a number of scheduled tasks for which the resources associated with the resource type and the department can be simultaneously assigned and for which the resources of the resource type and the department can be simultaneously assigned in excess of the value entered in the opening box, respectively.

Overall location opening and overbook limits may further be defined for the departments in the opening boxes 1036 and the overbook boxes 1038. First show area limit selector 1020 provides an indicator of whether or not conflict checking based on an area limit is performed when the resource type is scheduled. If first show area limit selector 1020 indicates that area limit conflict checking is not performed when the resource type is scheduled, the opening boxes 1036 and the overbook boxes 1038 may not include an area opening limit 1037 or an area overbook limit 1039. If first show area limit selector 1020 indicates that area limit conflict checking is performed when the resource type is scheduled, as shown in the illustrative embodiment with a checked check box, the opening boxes 1036 and the overbook boxes 1038 may include area opening limit 1037 or area overbook limit 1039. The values entered into or selected from area opening limit 1037 or area overbook limit 1039 are applied when scheduling the resource type across the departments defined for the location to ensure that sufficient resources are available across the areas.

When first department add time/date restriction button 1018 is selected by the user, a new window opens to allow the user to define a time/day window for defining another set of opening and overbook limits for the departments. For example, in the illustrative embodiment of FIG. 10, availability tab 904 in association with first location indicator 1010 shows a default time/day restriction indicator 1030 and a second time/day restriction indicator 1032. The plurality of area indicators 1031 is associated with default time/day restriction indicator 1030, and a second plurality of area indicators 1034 is associated with second time/day restriction indicator 1032. The second plurality of area indicators 1034 similarly include second opening boxes 1040 and second overbook boxes 1042. The values entered in second opening boxes 1040 and second overbook boxes 1042 are applied when scheduling the resource type for that facility/department during the time window defined by the user. For example, in the illustrative embodiment of FIG. 10, the values entered in second opening boxes 1040 and second overbook boxes 1042 are applied on Tuesday between 6 am and noon.

As an example, availability tab 904 allows the shared scheduling of anesthesiologists across multiple areas. Setting an area limit ensures that sufficient staff is available for a given day across areas such as operating rooms, radiology laboratories, and imaging laboratories, while setting department limits ensures that sufficient staff is available for specific areas such as the main operating rooms. If 14 is the predefined number of available anesthesiologists for a given time window, multiple utilizations of the anesthesiologists can be defined with restrictions as defined using opening boxes 1036 and overbook boxes 1038.

Availability tab 904 further may include a third accept button 1044 and a third cancel button 1046. With continuing reference to FIG. 4, in an operation 406, the resource type information entered/selected by the user is received and stored. For example, upon receipt of an indication of a user selection of third accept button 1044, the resource type information entered/selected by the user is received, resource type definition window 900 is closed, and the resource type information is stored in database 112. Upon receipt of an indication of a user selection of third cancel button 1046, resource type definition window 900 is closed without updating the resource type stored in database 112.

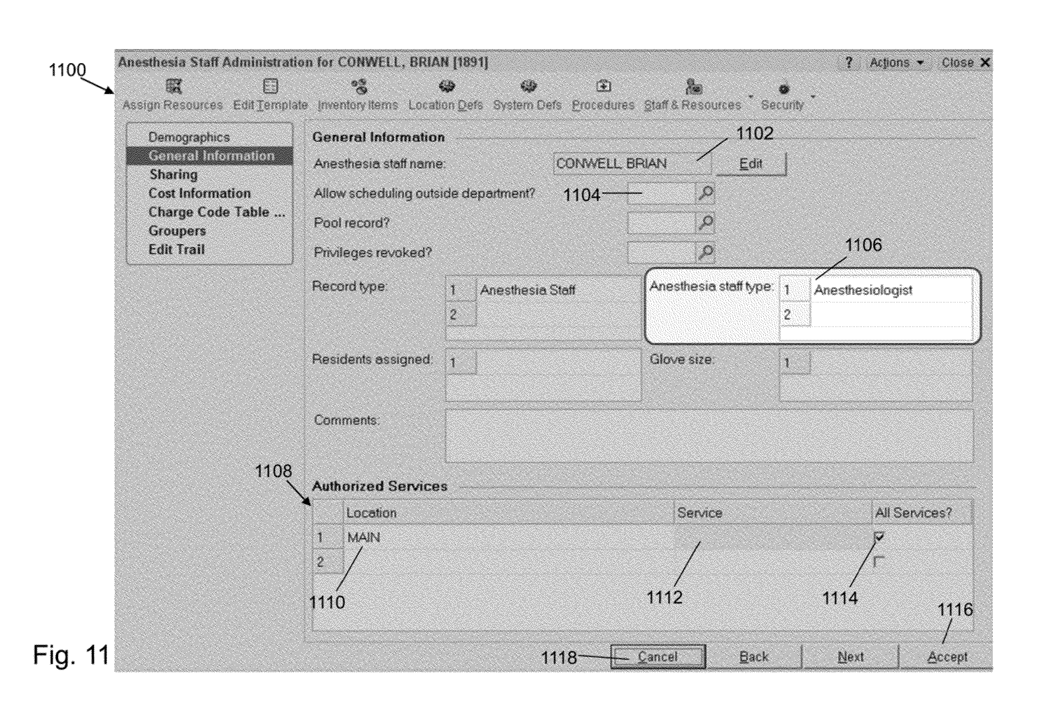

In an operation 408, a second indicator is received indicating that the user has selected a second selector to define and/or edit a resource. In an operation 410, a resource selection window may be presented in display 212 after selection of the second selector by the user. Similar to resource type selection window 700, the resource selection window may include selectors to allow the user to identify and select or create a new resource. In an operation 412 and with reference to FIG. 11, a resource definition window 1100 may be presented in display 212 after selection/creation of a resource presented in the resource selection window. Resource definition window 1100 may include a resource name box 1102, a department scheduling selector 1104, a resource type selector 1106, a service table 1108, a fourth accept button 1116, and a fourth cancel button 1118.

The user may enter alphanumeric characters in resource name box 1102 to provide an identifier for the resource to be created. Department scheduling selector 1104 allows the user to define whether or not the resource can be scheduled across multiple areas. If the user can be scheduled across multiple areas, department scheduling selector 1104 may allow the user to define the one or more areas to which the resource can be defined. Resource type selector 1106 allows the user to define one or more resource types for the resource. For example, if the resource is an anesthesiologist, the user may enter or select the resource type “anesthesiologist” using resource type selector 1106. A plurality of resource types may be selected for the resource.

Service table 1108 allows the user to define which services can be performed by the resource and at which locations. For example, service table 1108 may include a location indicator 1110, a service indicator 1112 associated with location indicator 1110, and an all services indicator 1114 also associated with location indicator 1110. In an illustrative embodiment, location indicator 1110 may allow the user to select/enter a facility or an area within the facility. Service indicator 1112 may allow the user to select/enter the services that can be performed by the resource at the selected/entered facility or area within the facility. All services indicator 1114 may provide an indicator of whether or not the resource can perform all services at the location. If services indicator 1114 is selected, service indicator 1112 may be “grayed out” to indicate no selection is needed using service indicator 1112 as understood by a person of skill in the art.

With continuing reference to FIG. 4, in an operation 414, the resource information entered/selected by the user is received and stored. For example, upon receipt of an indication of a user selection of fourth accept button 1116, the resource information entered/selected by the user is received, resource definition window 1100 is closed, and the resource information is stored in database 112. Upon receipt of an indication of a user selection of fourth cancel button 1118, resource definition window 1100 is closed without updating the resource stored in database 112.

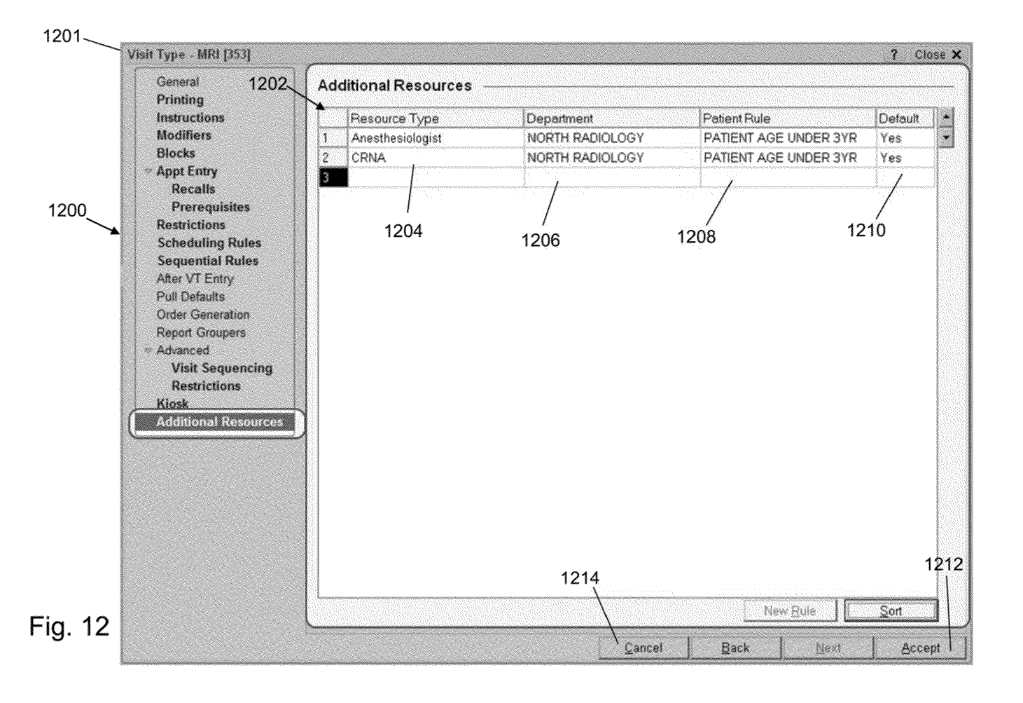

In an operation 416, a third indicator is received indicating that the user has selected a third selector to define and/or edit an appointment type. In an operation 418, an appointment type selection window may be presented in display 212 after selection of the third selector by the user. Similar to resource type selection window 700, the appointment type selection window may include selectors to allow the user to identify and select or create a new appointment type. In an operation 420 and with reference to FIG. 12, an appointment type definition window 1200 may be presented in display 212 after selection/creation of an appointment type presented in the appointment type selection window. In the illustrative embodiment of FIG. 12, appointment type definition window 1200 may include an appointment type name indicator 1201, a resource type table 1202, a fifth accept button 1212, and a fifth cancel button 1214.

Resource type table 1202 allows the user to define one or more resource types to possibly allocate when an appointment of the appointment type is scheduled. For example, resource type table 1202 may include a resource type indicator 1204, a department indicator 1206 associated with resource type indicator 1204, a rule indicator 1208 associated with resource type indicator 1204, and a default indicator 1210 also associated with resource type indicator 1204. Resource type indicator 1204 may allow the user to select/enter the resource type to allocate. A plurality of resource types may be selected for the appointment type. Department indicator 1206 may allow the user to select/enter the department from which the resource type is to be allocated. Rule indicator 1208 may allow the user to select/enter a rule to apply to determine if the resource type should be allocated to the appointment of the appointment type. Default indicator 1210 may allow the user to indicate whether or not the resource type is allocated by default when the appointment of the appointment type is scheduled without user intervention based on any rule selected/entered in rule indicator 1208. For example, in the illustrative embodiment of FIG. 12, the appointment type is a magnetic resonance imaging (MRI) appointment. The parameters selected/entered by the user in resource type table 1202 indicate that both an anesthesiologist and a certified registered nurse anesthetist (CRNA) should be allocated by default when the appointment of the appointment type is scheduled and the patient is under 3 years of age. When an MRI is to be scheduled for a patient under 3 years of age, the rules associated with the resource type, as discussed with reference to FIGS. 9 and 10, are applied to determine when it is appropriate to schedule the MRI.

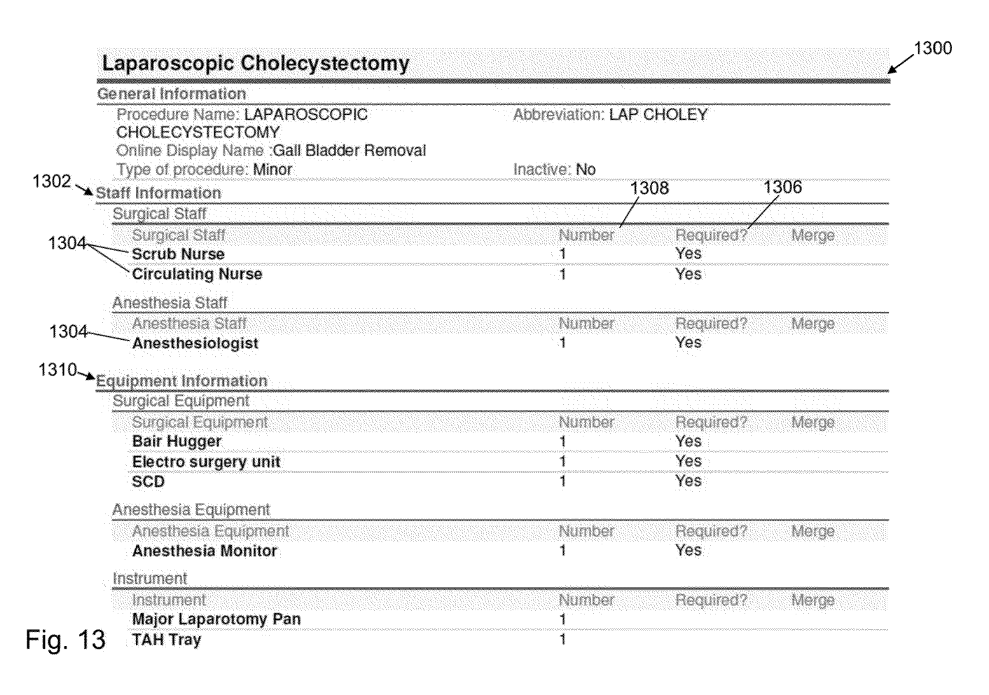

With reference to FIG. 13, a second appointment type definition window 1300 may be presented in display 212 after selection/creation of the appointment type presented in the appointment type selection window. In the illustrative embodiment of FIG. 13, second appointment type definition window 1300 may include a second resource type table 1302, a third resource type table 1310, a sixth accept button (not shown), and a sixth cancel button (not shown).

Second resource type table 1302 allows the user to define one or more resource types to possibly allocate when an appointment of the appointment type is scheduled. For example, second resource type table 1302 may include a resource type indicator 1304, a required indicator 1306 associated with each second resource type indicator 1304, and a number indicator 1308 associated with each second resource type indicator 1304. Second resource type table 1302 may allow the user to select/enter the resource type to allocate. A plurality of resource types may be selected for the appointment type. Required indicator 1306 may allow the user to indicate whether or not the resource type is required to be allocated when the appointment of the appointment type is scheduled. Number indicator 1308 may allow the user to select/enter a number of the resource type to be allocated. For example, two scrub nurses may be allocated to perform the appointment type which, in the illustrative embodiment of FIG. 13, is a Laparoscopic Cholecystectomy. The parameters selected/entered by the user in resource type table 1302 indicate that a Scrub Nurse, a Circulating Nurse, and an Anesthesiologist are required to be allocated when the surgery is scheduled. Specific individuals can be allocated to this type of surgery appointment according to the resource type rule parameters as discussed in FIGS. 9 and 10.

Similar to second resource type table 1302, third resource type table 1310 allows the user to define one or more resource types to possibly allocate when an appointment of the appointment type is scheduled. In the illustrative embodiment of FIG. 13, second resource type table 1302 is used to allocate personnel, and third resource type table 1310 is used to allocate equipment used during the surgery type appointment.

With continuing reference to FIG. 4, in an operation 422, the appointment type information entered/selected by the user is received and stored. For example, upon receipt of an indication of a user selection of fifth accept button 1216 or the sixth accept button, the resource information entered/selected by the user is received, appointment type definition window 1200 or second appointment type definition window 1300 is closed, and the appointment type information is stored in database 112. Upon receipt of an indication of a user selection of fifth cancel button 1218 or the sixth cancel button, appointment type definition window 1200 or second appointment type definition window 1300 is closed without updating the appointment type information stored in database 112.

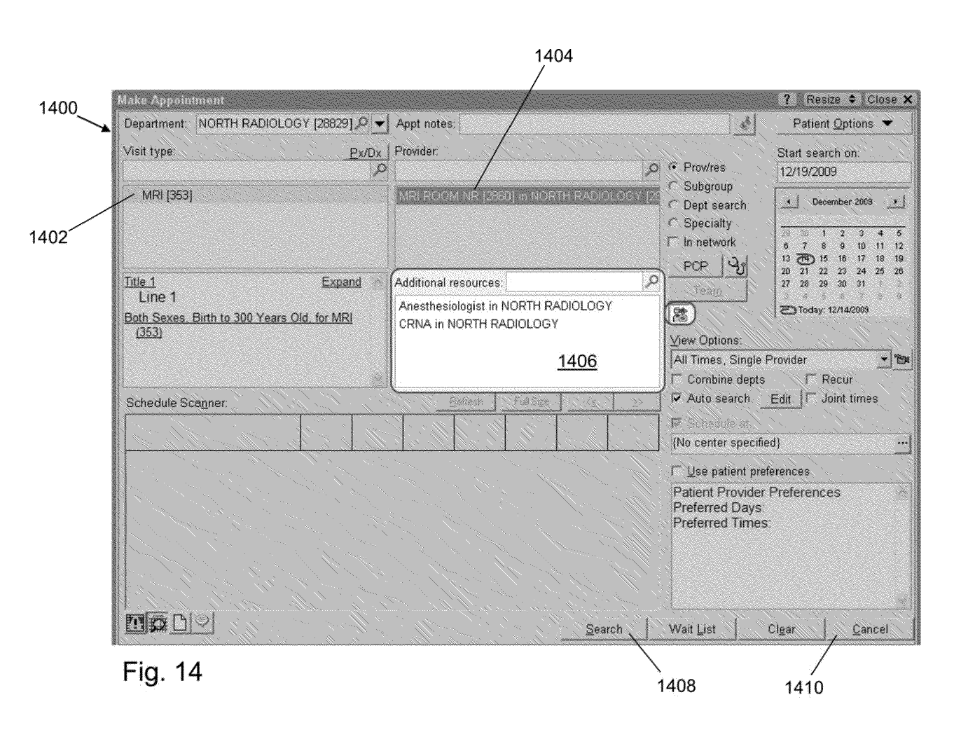

In an operation 424, a fourth indicator is received indicating that the user has selected a fourth selector to schedule an appointment. For example, with reference to FIG. 14, an appointment scheduling window 1400 may be presented in display 212 after receipt of the fourth indicator. In the illustrative embodiment of FIG. 14, appointment scheduling window 1400 may include a second appointment type name indicator 1402, an appointment location indicator 1404, a resource type indicator 1406, a search button 1408, and a seventh cancel button 1410. Resource type indicator 1406 indicates one or more resource types to possibly allocate when scheduling the appointment. Search button 1408 is selected to execute a search for the appointment.

In an operation 426, conflict rules are applied to schedule the appointment. For example, in the illustrative embodiment of FIG. 14, the appointment type to schedule is an MRI, which, as described with reference to FIG. 12, requires allocation of an anesthesiologist if the patient is less than three years of age. Thus, if the patient is less than three years of age, the allocation limits as defined with reference to FIGS. 9 and 10 are applied when scheduling the MRI. A specific anesthesiologist is not scheduled at the time of scheduling the appointment, but the group limits are applied to ensure that a sufficient number of anesthesiologists are available at the selected time across areas given the previously scheduled appointments for each time period evaluated for scheduling of the appointment. In an operation 427, the appointment scheduling information is stored in database 112 unless seventh cancel button 1410 is selected.

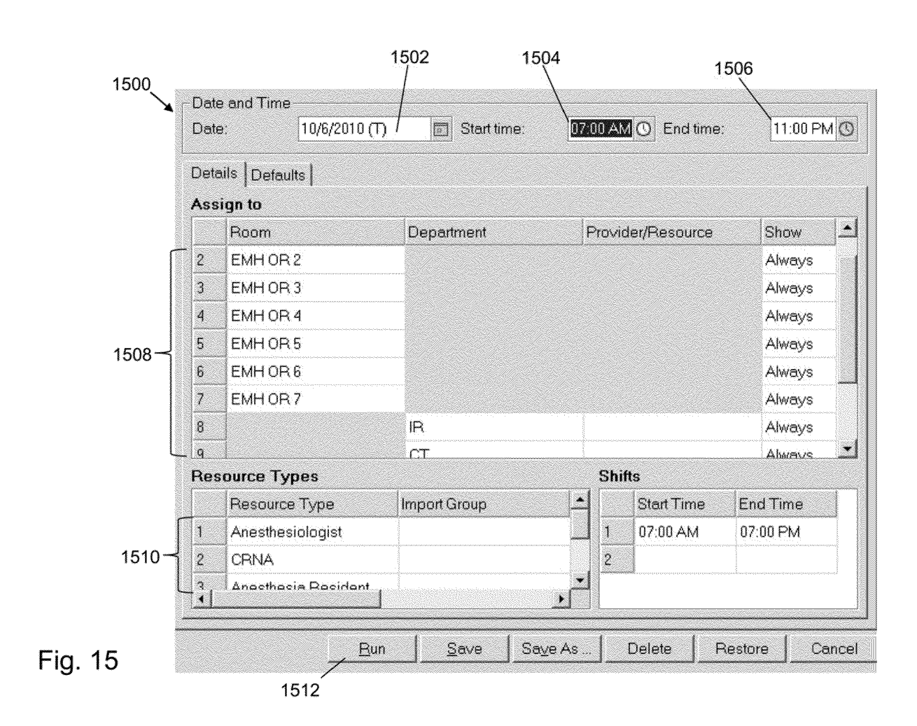

Later in time, for example, the evening before or the morning of, resources are assigned to scheduled appointments. As a result, in an operation 428, a fifth indicator is received indicating that the user has selected a fifth selector to assign resources to scheduled appointments. In an operation 430 and with reference to FIG. 15, a resource assignment selector window 1500 may be presented in display 212 after receipt of the fifth indicator. In the illustrative embodiment of FIG. 15, resource assignment selector window 1500 may include an assignment date selector 1502, an assignment start time selector 1504, an assignment stop time selector 1506, a plurality of resource assignment groups 1508, a plurality of resource types 1510, and a run button 1512. Use of assignment date selector 1502 allows the user to select the date on which the resources are to be assigned. Use of assignment start time selector 1504 allows the user to select the start time on the date on which the resources are to be assigned. Use of assignment stop time selector 1506 allows the user to select the stop time on the date on which the resources are to be assigned. Using the plurality of resource assignment groups 1508, the user defines the group to be assigned resources and/or to be scheduled with unscheduled appointments. For example, the group may be associated with a room in which certain types of appointments are conducted, a department in which the certain types of appointments are conducted, a specific resource, etc. Using the plurality of resource types 1510, the user defines the resource types to be assigned to the plurality of resource assignment groups 1508 on the date selected using assignment date selector 1502 and during the time window defined using assignment start time selector 1504 and assignment stop time selector 1506. User selection of run button 1512 causes creation of a schedule based on the user selections from resource assignment selector window 1500.

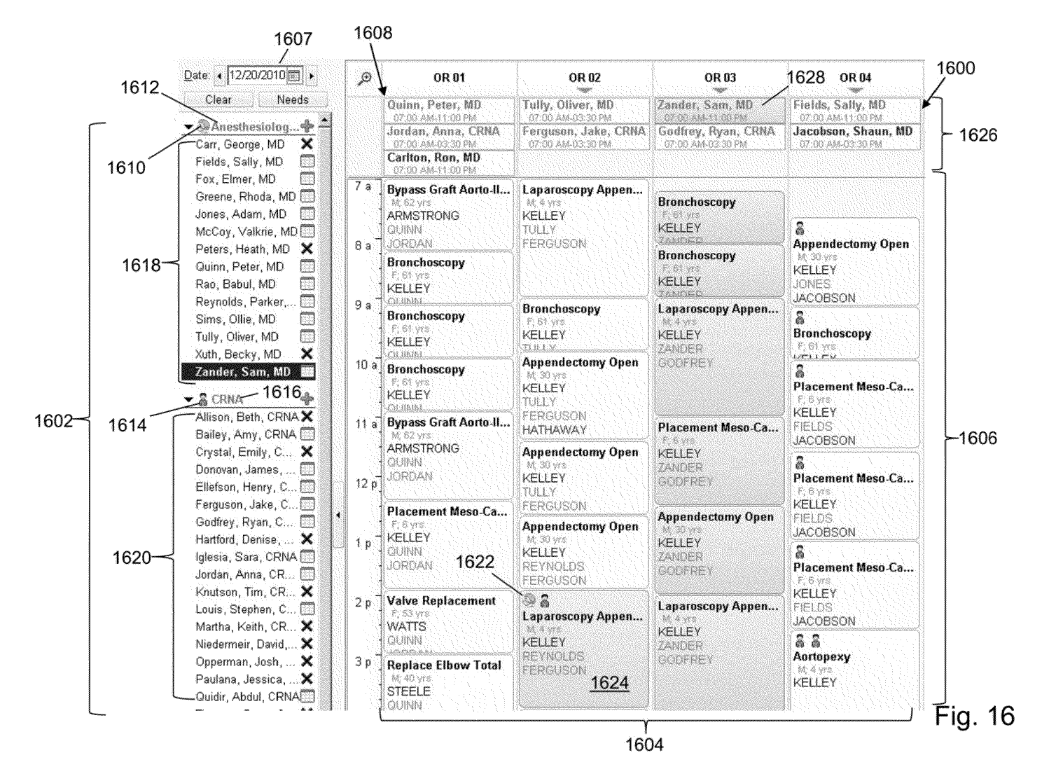

For example, with reference to FIG. 16, a resource scheduling and assignment window 1600 is shown in accordance with an illustrative embodiment. Resource scheduling and assignment window 1600 may be presented in display 212 after receipt of a sixth indicator indicating selection of run button 1512. In the illustrative embodiment of FIG. 16, resource scheduling and assignment window 1600 may include resource type indicators 1602, resource assignment group indicators 1604, and a resource assignment timeline 1606 for a selected date 1607. Resource type indicators 1602 include indicators for the plurality of resource types 1510 selected using resource assignment selector window 1500. Resource assignment group indicators 1604 include indicators for the plurality of resource assignment groups 1508 selected using resource assignment selector window 1500. Resource assignment timeline 1606 includes a time scale defined based on an assignment start time and an assignment stop time selected using assignment start time selector 1504 and assignment stop time selector 1506, respectively, of resource assignment selector window 1500 for selected date 1607. The resource assignment group indicators 1604 and the resource assignment timeline 1606 form a table 1608 with table entries defining the appointments scheduled for each resource assignment group of the plurality of resource assignment groups 1508 during the time window defined by resource assignment timeline 1606.

In the illustrative embodiment of FIG. 16, resource type indicators 1602 include a first resource type indicator 1610, a first resource type name 1612, a second resource type indicator 1614, and a second resource type name 1616. For example, first resource type indicator 1610 includes an icon selected to represent the resource type “anesthesiologist” using icon indicator 910, and first resource type name 1612 includes the text “anesthesiologist” shown in a color selected to represent the resource type “anesthesiologist” using color indicator 916. A first plurality of resources 1618 are associated with first resource type indicator 1610 and first resource type name 1612. The first plurality of resources 1618 include a list of the resources of the “anesthesiologist” resource type that are available to be assigned to table entries 1608 on the selected date 1607. Second resource type indicator 1614 includes an icon selected to represent the resource type “CRNA” using icon indicator 910, and second resource type name 1616 includes the text “CRNA” shown in a color selected to represent the resource type “CRNA” using color indicator 916. A second plurality of resources 1620 are associated with second resource type indicator 1614 and second resource type name 1616. The second plurality of resources 1620 include a list of the resources of the “CRNA” resource type that are available to be assigned to table entries 1608 on the selected date 1607.

A table entry 1624 for an appointment indicated in table entries 1608 may include a needed resource indicator 1622. As an example, in the illustrative embodiment of FIG. 16, an appointment for a laparoscopic appendectomy scheduled for 2 pm in operating room 2 includes the icon selected to represent the resource type “anesthesiologist” and the icon selected to represent the resource type “CRNA” indicating that an anesthesiologist and a CRNA need to be assigned to the appointment. An anesthesiologist resource of the first plurality of resources 1618 can be selected, for example, using mouse 220 and/or display 212, and dragged to table entry 1624. As a result, the selected anesthesiologist is assigned to the appointment. Similarly, a CRNA resource of the second plurality of resources 1620 can be selected and dragged to table entry 1624 to assign the selected CRNA to the appointment. The icon selected to represent the resource type “anesthesiologist” and the icon selected to represent the resource type “CRNA” may be removed from table entry 1624 to indicate that no additional resources are needed.

To assign a resource to a plurality of the table entries of table 1608, a resource of the first plurality of resources 1618 and/or of the second plurality of resources 1620 may be dragged to an assignment area 1626 above resource assignment timeline 1606 and below each resource assignment group indicator of the resource assignment group indicators 1604. An assigned resource indicator 1628 indicates that the resource has been assigned to the resource assignment group and each appointment of the table entries of table 1608 associated with that resource assignment group is updated to indicate that the resource has been assigned to each appointment where a resource of that resource type is needed. For example, in the illustrative embodiment of FIG. 16, an anesthesiologist resource named “Sam Zander” has been assigned to each appointment scheduled for operating room 3 that is indicated to need an “anesthesiologist” resource type.

With continuing reference to FIG. 4, in an operation 432, the assignment information including the assigned resource information is received and stored in database 112. In an operation 434, the schedule for the assigned resource is updated to reflect the assignment. For example, upon receipt of an indication of a dropping of a resource indicator onto a table entry of table 1608, a schedule of the resource associated with the resource indicator is updated.

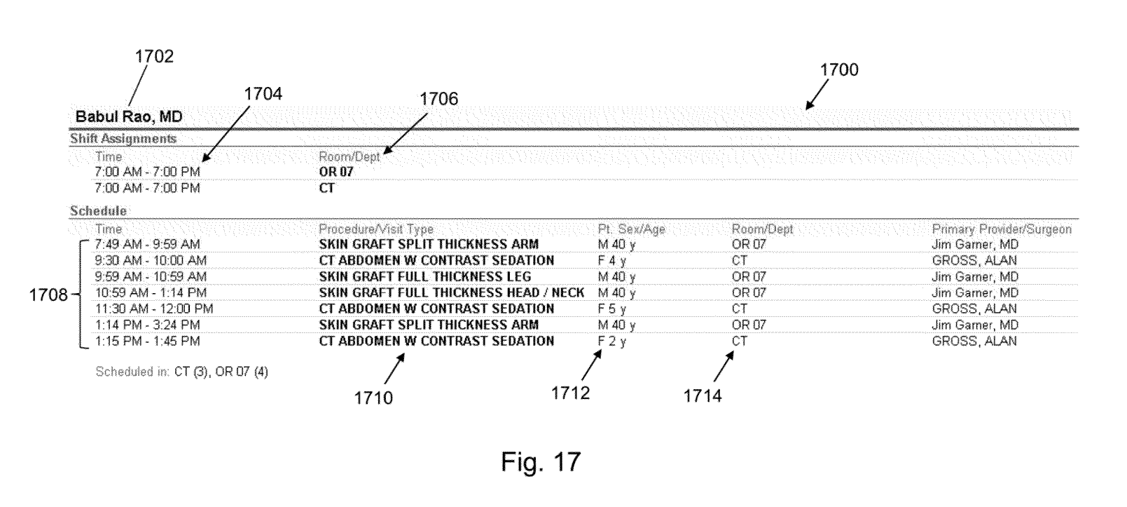

As an example, with reference to FIG. 17, a schedule 1700 for a first resource indicator 1702 named “Babul Rao” is shown in accordance with an illustrative embodiment. Schedule 1700 may include a shift assignment indicator 1704 that indicates the time window for the shift and a shift assignment area 1706 for the shift of the resource associated with first resource indicator 1702. Schedule 1700 further may include a plurality of appointment time windows 1708. For each appointment of the plurality of appointment time windows 1708, an appointment description 1710, patient information 1712, and an appointment area 1714 may be shown including the appointments assigned using resource scheduling and assignment window 1600.

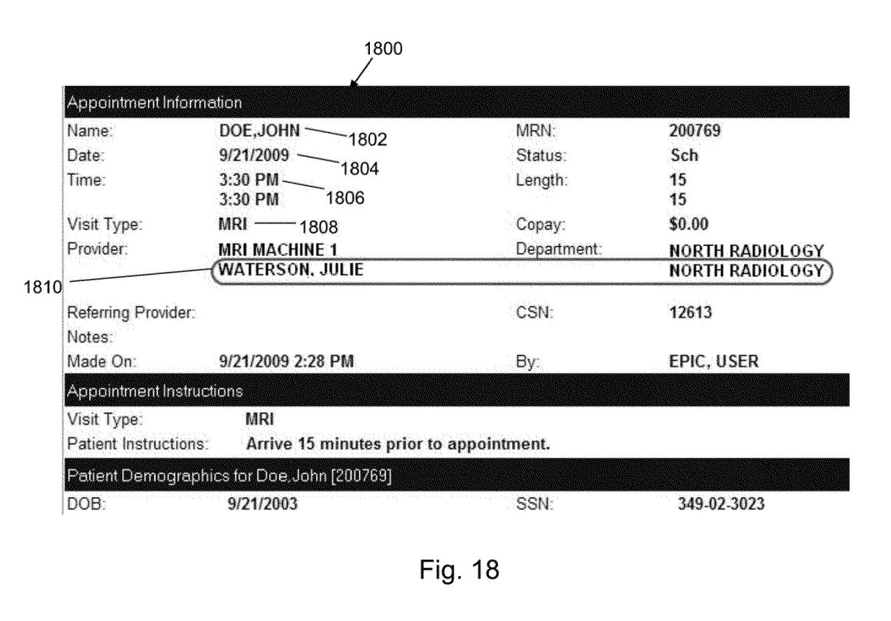

Additionally, with continuing reference to FIG. 4, in an operation 436, the appointment is updated to reflect the assigned resource. As an example, with reference to FIG. 18, a first appointment 1800 is shown in accordance with an illustrative embodiment. First appointment 1800 may include a patient name 1802, an appointment date 1804, an appointment time window 1806, an appointment type 1808, and an assigned resource indicator 1810 associated with the resource assigned using resource scheduling and assignment window 1600.

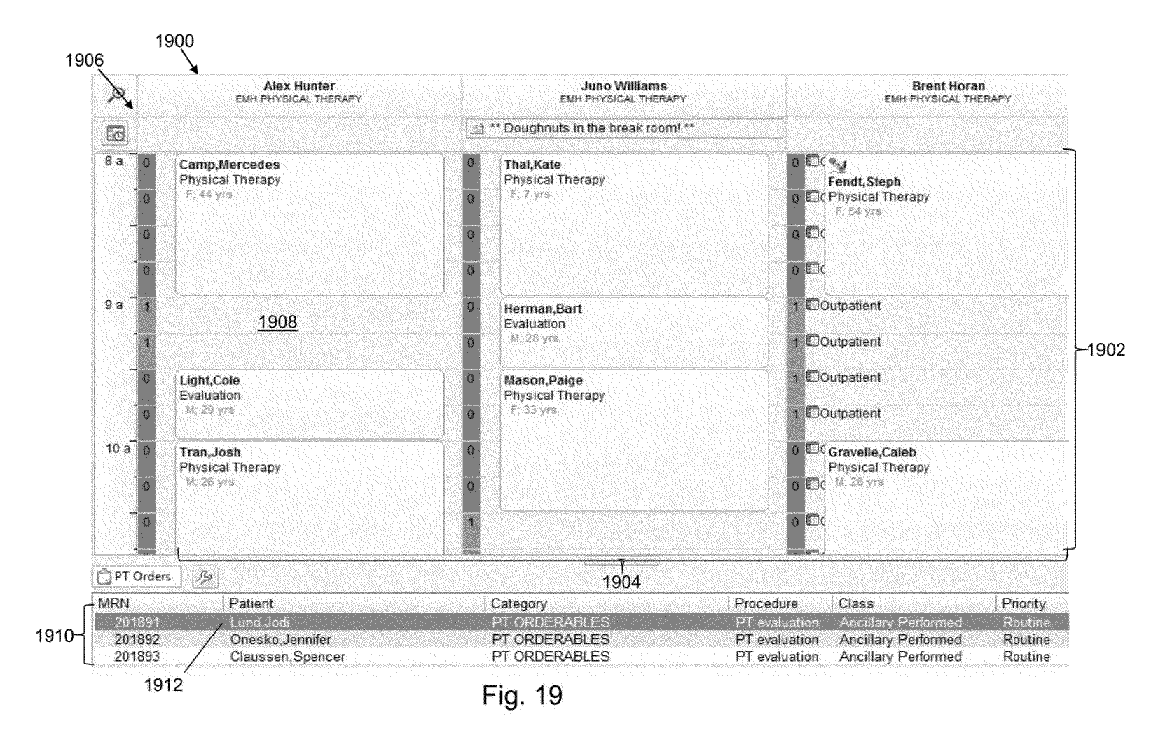

With reference to FIG. 19, a second resource scheduling and assignment window 1900 is shown in accordance with a second illustrative embodiment. Second resource scheduling and assignment window 1900 may be presented in display 212 after receipt of a seventh indicator indicating selection of run button 1512. In the illustrative embodiment of FIG. 19, second resource scheduling and assignment window 1900 may include a second resource assignment timeline 1902 and second resource assignment group indicators 1904 for a selected date. Second resource assignment group indicators 1904 include indicators for the plurality of resource assignment groups 1508 selected using resource assignment selector window 1500. In the illustrative embodiment of FIG. 19, the resource assignment groups are associated with physical therapists of a “physical therapist” resource type. Second resource assignment timeline 1902 includes a time scale defined based on an assignment start time and an assignment stop time selected using assignment start time selector 1504 and assignment stop time selector 1506, respectively, of resource assignment selector window 1500 for the selected date. The second resource assignment group indicators 1904 and the second resource assignment timeline 1902 form a second table 1906 defining the appointments scheduled for each resource assignment group of the plurality of resource assignment groups 1508 during the time window defined by second resource assignment timeline 1902. In the illustrative embodiment of FIG. 19, a resource assignment group is an individual resource of the “physical therapist” resource type. Thus, second resource scheduling and assignment window 1900 shows a schedule for a plurality of physical therapists including any openings in the schedule. For example, an opening 1908 is indicated in second table 1906 for a physical therapist resource name “Alex Hunter” in the illustrative embodiment of FIG. 19.

In the illustrative embodiment of FIG. 19, second resource scheduling and assignment window 1900 further may include a plurality of unscheduled appointment indicators 1910. To schedule an unscheduled appointment indicated by an unscheduled appointment indicator of the plurality of unscheduled appointment indicators 1910, the unscheduled appointment indicator can be dragged to a table entry of second table 1906. Information associated with the table entry such as the time window and the resource associated with the table entry is used in combination with information associated with the unscheduled appointment to determine if it is acceptable, according to scheduling rules, to schedule the unscheduled appointment in the table entry. If it is determined to be acceptable to schedule the unscheduled appointment in the table entry, second table 1906 is updated to reflect the now scheduled appointment. The appointment and the schedule of the assigned resource are updated to reflect the scheduled appointment. For example, a first unscheduled appointment indicator 1912 for a patient named “Jodi Lund” may be dragged to opening 1908. As a result, the appointment information associated with first unscheduled appointment indicator 1912 is updated to reflect the appointment time, date, and resource assignment, and the schedule for the physical therapist resource name “Alex Hunter” is updated to reflect the appointment.

Using the described “drag-and-drop” features allows users to schedule an appointment by dragging a patient onto the schedule of a resource making scheduling appointments easier and faster and simplifying rescheduling in areas with more dynamic schedules like inpatient rehabilitation by allowing “drag-and-drop” between schedules. Additionally, “drag-and-drop” feature allows resource types like anesthesiologists to be assigned to appointments or to an assignment group, such as a department or operating room, easier and faster.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A non-transitory computer-readable medium having stored thereon computer-readable instructions that when executed by a computing device cause the computing device to:
receive a resource type definition defining first characteristics of a resource type;
receive an appointment type definition defining third characteristics of an appointment type;
receive appointment parameters associated with an appointment to schedule, wherein the appointment parameters include the appointment type and the resource type to be used in conducting the appointment;
schedule the appointment for a date and a time window using a number of resources of the resource type available on the date and during the time window and information associated with previously scheduled appointments; and
after scheduling the appointment, assign a resource of the resource type to the scheduled appointment.

2. The computer-readable medium of claim 1, wherein the computer-readable instructions further cause the computing device to update a schedule of the assigned resource to include the scheduled appointment.

3. The computer-readable medium of claim 1, wherein the computer-readable instructions further cause the computing device to update appointment information of the scheduled appointment to include the assigned resource.

4. The computer-readable medium of claim 1, wherein the resource type is selected from the group consisting of a type of person who may have specific qualifications to conduct the appointment, a type of equipment used to conduct the appointment, and a type of area in which to conduct the appointment.

5. The computer-readable medium of claim 1, wherein the appointment is associated with a task to be performed on the date and during the time window.

6. The computer-readable medium of claim 1, wherein the resource of the resource type is assigned by receiving an indicator of dragging and dropping a resource indicator for the resource onto an appointment indicator for the appointment.

7. The computer-readable medium of claim 6, wherein the computer-readable instructions further cause the computing device to present a resource assignment selector window after scheduling the appointment and before assigning the resource, wherein the resource assignment selector window includes a resource type selector, a date selector, and a time window selector.

8. The computer-readable medium of claim 7, wherein the computer-readable instructions further cause the computing device to present a resource scheduling and assignment window after presenting the resource assignment selector window and before assigning the resource, wherein the resource scheduling and assignment window includes a plurality of resource indicators defined based on the resource type selector and a resource assignment timeline defined by the time window selector for a date defined by the date selector, wherein the resource indicator for the resource is included in the plurality of resource indicators and the appointment indicator is included in the resource assignment timeline.

9. The computer-readable medium of claim 8, wherein the resource assignment selector window further includes a resource assignment group selector, wherein the resource scheduling and assignment window further includes a plurality of resource assignment group indicators defined based on the resource assignment group selector, and further wherein the appointment indicator is included in the resource assignment timeline for an assignment group of the plurality of resource assignment group indicators.

10. The computer-readable medium of claim 9, wherein the resource of the resource type is assigned by receiving an indicator of dragging and dropping a resource indicator for the resource onto a resource assignment group of the plurality of resource assignment group indicators.

11. The computer-readable medium of claim 10, wherein the resource is assigned to each appointment of the resource assignment group that indicates a need for the resource type to conduct the appointment.

12. The computer-readable medium of claim 6, wherein the appointment indicator includes a needed resource indicator indicating a need for the resource type to conduct the appointment.

13. The computer-readable medium of claim 12, wherein the needed resource indicator is an icon selected to represent the resource type.

14. The computer-readable medium of claim 13, wherein the computer-readable instructions further cause the computing device to present a resource assignment selector window after scheduling the appointment and before assigning the resource, wherein the resource assignment selector window includes a resource type selector, a date selector, and a time window selector.

15. The computer-readable medium of claim 14, wherein the computer-readable instructions further cause the computing device to present a resource scheduling and assignment window after presenting the resource assignment selector window and before assigning the resource, wherein the resource scheduling and assignment window includes a plurality of resource indicators defined based on the resource type selector and a resource assignment timeline defined by the time window selector for a date defined by the date selector, wherein the resource indicator for the resource is included in the plurality of resource indicators and the appointment indicator is included in the resource assignment timeline, and further wherein the icon is removed from the appointment indicator after assigning the resource to the appointment.

16. The computer-readable medium of claim 1, wherein the resource of the resource type is assigned by receiving an indicator of dragging and dropping an appointment indicator for the appointment onto an open time window associated with a schedule for the resource.

17. The computer-readable medium of claim 16, wherein the computer-readable instructions further cause the computing device to present a resource assignment selector window after scheduling the appointment and before assigning the resource, wherein the resource assignment selector window includes a resource type selector, a date selector, and a time window selector.

18. The computer-readable medium of claim 17, wherein the computer-readable instructions further cause the computing device to present a resource scheduling and assignment window after presenting the resource assignment selector window and before assigning the resource, wherein the resource scheduling and assignment window includes a plurality of resource indicators defined based on the resource type selector, a resource assignment timeline for the plurality of resource indicators, and the appointment indicator, wherein the open time window of the resource is included in the resource assignment timeline in association with a resource indicator for the resource.

19. A system comprising:
a processor; and
a computer-readable medium operably coupled to the processor, the computer-readable medium having computer-readable instructions stored thereon that, when executed by the processor, cause the system to
receive a resource type definition defining first characteristics of a resource type;
receive an appointment type definition defining third characteristics of an appointment type;
receive appointment parameters associated with an appointment to schedule, wherein the appointment parameters include the appointment type and the resource type to be used in conducting the appointment;
schedule the appointment for a date and a time window using a number of resources of the resource type available on the date and during the time window and information associated with previously scheduled appointments; and
after scheduling the appointment, assign a resource of the resource type to the scheduled appointment.

20. A method of scheduling use of a resource based on a resource type and of assigning the resource to an appointment, the method comprising:
receiving, by a computing device, a resource type definition defining first characteristics of a resource type;
receiving, by the computing device, an appointment type definition defining third characteristics of an appointment type;
receiving, by the computing device, appointment parameters associated with an appointment to schedule, wherein the appointment parameters include the appointment type and the resource type to be used in conducting the appointment;
scheduling, by the computing device, the appointment for a date and a time window using a number of resources of the resource type available on the date and during the time window and information associated with previously scheduled appointments; and
after scheduling the appointment, assigning, by the computing device, a resource of the resource type to the scheduled appointment.
